(19) United States
(12) Patent Application Publication
(10) Pub. No.: US 2010/0138655 A1
(43) Pub. Date: Jun. 3, 2010

(54) TERMINAL APPARATUS AND OPERATION INFORMATION COLLECTING SYSTEM

(75) Inventors: Kazuki MATSUI, Kawasaki (JP); Masahiko MURAKAMI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/620,800

(22) Filed: Nov. 18, 2009

(30) Foreign Application Priority Data
Nov. 21, 2008 (JP) 2008-298117

(51) Int. Cl. G06F 15/16; H04L 9/32

(52) U.S. Cl. 713/168; 709/224

(57) ABSTRACT

A terminal apparatus includes a receiving unit for receiving content data having definition information containing information regarding collection of operation information and information limiting a destination of the operation information; a playback processing unit for playing back the content data; a separating unit for separating the definition information from the content data, an operation-log collecting unit for collecting an operation log based on the information regarding the collection of the operation information; an operation-information generating unit for generating operation information from the operation log; a transmission enabling/disabling determining unit for determining whether or not transmission of the operation information is enabled, and a transmitting unit for transmitting the operation information to an information collecting server in response to a user operation that causes data communication, when the transmission enabling/disabling determining unit determines that transmission of the operation information is enabled.

### CROSS-REFERENCE TO RELATED APPLICATIONS

This application is based upon and claims the benefit of priority of the prior Japanese Patent Application No. 2008-298117, filed on Nov. 21, 2008, the entire contents of which are incorporated herein by reference.

### FIELD

The embodiments discussed herein relate to a terminal apparatus and an operation-information collecting system which handle content data.

### BACKGROUND

Sampling is often performed for collection of ratings information for

TV broadcasts and radio broadcasts aimed for people in households. With the widespread use of mobile phones and availability of one-segment broadcasting, broadcasts have been widely viewed and/or listened to in mobile environments in different manners in households.

In particular, cases in which broadcast data are electronically stored so that desired information thereof is later viewed and/or listened to at free times are increasing. In conjunction with broader bandwidths in mobile communication environments, it is considered that broadcast-based content may be increasingly enjoyed in mobile environments in the future.

One example of content distribution technology aimed for multi-channel broadcasting for mobile phones is a Media FLO system of QUALCOMM incorporated. In the Media FLO System, video-type data is transmitted from a server to a terminal apparatus in a VHF (very high frequency) band and operation information and so on are transmitted from the terminal apparatus to the server by using IP packets, so that real-time streaming TV broadcasting, streaming music broadcasting, and download-type clip casting may be used. In addition, the Media FLO system allows content to be customized for each user of the terminal apparatus.

The users of mobile terminals, such as mobile phones and smart phones, view and/or listen to different types of content by using individual methods in accordance with their respective needs. Thus, with the known approach for ratings-information collection using sampling, it has been difficult to collect ratings information with sufficient accuracies.

In the current circumstances, it is technically difficult and costly to collect ratings information of one-segment broadcasts for mobile phones, storage-type content (i.e., content which is temporarily and electronically stored broadcast data and may be played back later), and content viewed and/or listened to using personal computers (PCs). Thus, ratings information is not sufficiently collected. In particular, since it is expected that more personalized broadcasts (content) may be supplied in the future, there is a need for a novel ratings-information collecting method for dealing with such personalized broadcasts.

Various methods for collecting ratings information for broadcasting for mobile terminals have been proposed (refer to Japanese Unexamined Patent Application Publication No. 2004-274394). Known methods for collecting ratings information are performed, for example, in the following manner.

(1) While broadcasting a regular program, a digital broadcast station always broadcasts a data broadcast program that includes scripts stating an instruction for a mobile terminal to execute an operation corresponding to a trigger signal transmitted from the digital broadcast station.

(2) The mobile terminal always tunes into the data broadcast program and the digital broadcast station repeatedly transmits the trigger signal to the mobile terminal at regular intervals.

(3) The mobile terminal that has received the trigger signal transmits, as program viewing and/or listening data, identification information of an antenna currently used for the mobile communication and identification information of a program currently viewed and/or listened to a server at a viewing and/or listening information collecting organization.

### SUMMARY

According to an aspect of the invention, a terminal apparatus includes a receiving unit for receiving content data having definition information containing information regarding collection of operation information and information limiting a destination of the operation information; a playback processing unit for playing back the content data; a separating unit for separating the definition information from the content data, operation-log collecting unit for collecting an operation log based on the information regarding the collection of the operation information; an operation-information generating unit for generating operation information from the operation log; a transmission enabling/disabling determining unit for determining whether or not transmission of the operation information is enabled, based on the information limiting the destination of the operation information; and a transmitting unit for transmitting the operation information to an information collecting server in response to a user operation that causes data communication, when the transmission enabling/disabling determining unit determines that transmission of the operation information is enabled.

The object and advantages of the invention will be realized and attained by unit of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating the configuration of an operation information collecting system according to one embodiment;

FIG. 2 is a block diagram illustrating an operation-information collecting system according to one embodiment;

FIG. 3 is a flowchart of one embodiment of a flow of processing of a mobile phone;

FIG. 4 illustrates one example of a form that defines a link or button;

FIG. 5 is a block diagram illustrating an operation-information collecting system according to a second embodiment;

FIG. 6 is a flowchart of one embodiment of a flow of processing of a mobile phone; and

FIG. 7 is a flowchart of one embodiment of a flow of processing of the mobile phone.

### DESCRIPTION OF EMBODIMENTS

Known methods for collecting ratings information have the advantages of being able to collect ratings information in real time and being able to collect position information. The known ratings-information collecting methods, however, are restrictive of ratings information of real-time broadcast programs and thus cannot be applied to download-type content.

For example, in a mobile environment of a mobile phone or the like, the user thereof may view and/or listen to a broadcast while performing an operation on the screen of the mobile phone or the like. Also, for a broadcast in a mobile environment of a mobile phone or the like, the user may view or listen to the broadcast through pre-storage of data of the broadcast in a different environment, such as a PC environment, and by copying the pre-stored broadcast data from the PC environment or the like.

In addition, in a mobile environment of a mobile phone or the like, during playback of broadcast data copied from another environment such as a PC environment, the user may access a web site in order to collect information associated with the broadcast.

For example, if broadcast content (e.g., soccer broadcast content, drama program content, and music program content) may be understood by users accessing a web-site, it is possible to collect user preference information with high accuracy.

If user preference information may be collected with higher accuracy, the accessed web site may present a web page customized for the user to make it possible to further enhance convenience and user satisfaction. If the user preference information may be collected with higher accuracy, the usage rate of (or a repeated usage rate) of the web site may be increased.

However, the known ratings-information collecting method lacks a system for notifying, if the user accesses a web site in order to collect information associated with a broadcast during playback of data of the broadcast, the web site about the broadcast content viewed and/or listened to during the access. Unlimitedly notifying the web site about broadcast content viewed and/or listened to by a user during access is not preferable in terms of user privacy protection.

An object of one embodiment is to provide a terminal apparatus and an operation-information collecting system which are capable of more accurately collecting preference information of a user who plays back content data.

In order to address the above-described problems, one embodiment of the present invention provides a terminal apparatus. The terminal apparatus includes a receiving unit for receiving content data having definition information containing information regarding collection of operation information and information limiting a destination of the operation information; a playback processing unit for playing back the content data; a separating unit for separating the definition information from the content data; an operation-log collecting unit for collecting an operation log based on the information regarding the collection of the operation information; an operation-information generating unit for generating operation information from the operation log; a transmission enabling/disabling determining unit for determining whether or not transmission of the operation information is enabled, based on the information limiting the destination of the operation information; and a transmitting unit for transmitting the operation information to an information collecting server in response to a user operation that causes data communication, when the transmission enabling/disabling determining unit determines that transmission of the operation information is enabled.

The elements according to the embodiments or any combination of representations or the elements may be applied to a method, an apparatus, a system, a computer program, a storage medium, and a data structure, and such an application is also effective in modes of the present invention.

According to one embodiment, it is possible to provide a terminal apparatus and an operation-information collecting system which are capable of more accurately collecting preference information of a user who plays back content data.

Embodiments will now be described with reference to the accompanying drawings.

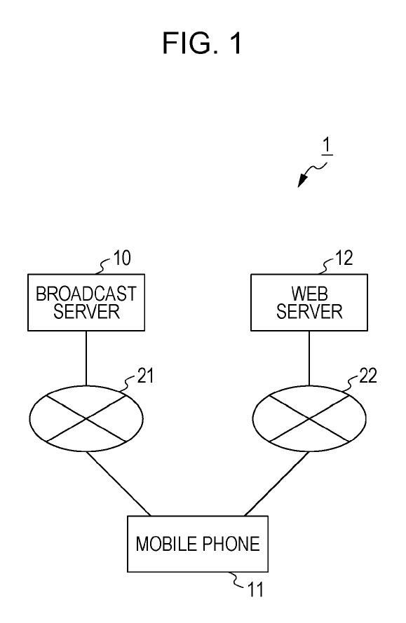

FIG. 1 is a diagram illustrating the configuration of an operation-information collecting system according to one embodiment. An operation-information collecting system 1 in FIG. 1 has a broadcast server 10, a mobile phone 11, a web server 12, a broadcast network 21, and a communications network 22. The broadcast server 10 is one example of a content transmitting server. The mobile phone 11 is one example of a terminal apparatus. The web server 12 is one example of an information collecting server.

The broadcast server 10 transmits broadcast data having definition information (described below) to the mobile phone 11 over the broadcast network 21. The mobile phone 11 transmits broadcast data having definition information over the broadcast network 21. The mobile phone 11 receives the broadcast data having the definition information. During playback of the broadcast data, the mobile phone 11 collects operation information regarding, for example, viewing and/or listening “while performing an operation” on a screen of the mobile phone 11. The expression “viewing and/or listening while performing an operation” refers to, for example, a state in which during playback of broadcast data, the user of the mobile phone 11 is accessing the web server 12 in order to collect information associated with the broadcast.

Based on the definition information, the mobile phone 11 collects operation information under a certain restriction as described below. Based on the definition information, the mobile phone 11 transmits the collected operation information to the web server 12 over the communications network 22 under a certain condition as described below.

Based on the received operation information, the web server 12 may learn preference information of the user of the mobile phone 11 with higher accuracy and may utilize the user preference information, for example, to optimize advertisement and to produce web pages.

In the operation-information collecting system 1 in FIG. 1, when the mobile phone 11 stores and plays back broadcast data having the definition information, it is possible to collect operation information without placing a large amount of operation load on the user. When broadcast data being played back and a web page are simultaneously displayed in multiple windows, operation information regarding the playback of the broadcast data may be transmitted to the web server 12 that is simultaneously displaying a screen, and also the contents of operation information to be collected and a supply range (a destination) of the operation information may be limited in advance.

### First Embodiment

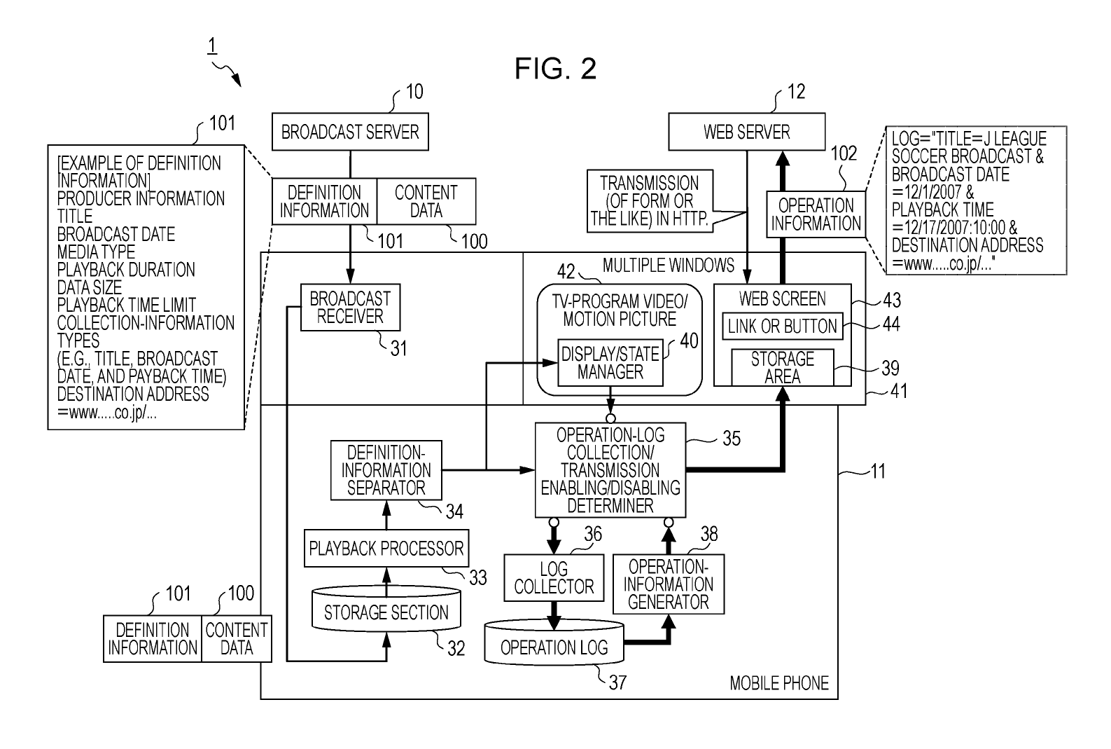

FIG. 2 is a block diagram of the configuration of an operation-information collecting system according to one embodiment. An operation-information collecting system 1 in FIG. 2 includes a broadcast server 10, a mobile phone 11, and a web server 12.

The broadcast server 10 transmits content data 100, such as TV content data or movie content data, through broadcast waves. The content data 100 transmitted by the broadcast server 10 has a header field that contains definition information 101. The definition information 101 contains, for example, producer information, a title, broadcast date, playback duration, data size, and so on as information regarding the content data 100.

The definition information 101 further contains a media type (a format type) and so on, which define a data type of the content data 100. The definition information 101 also contains a playback time limit as a limitation associated with a copyright.

Also, the definition information 101 contains a title, broadcast date, playback time, and so on as collection-information types that define data to be collected as operation information. The definition information 101 further contains a destination address and so on, which define a destination of the operation information (and which enable transmission of the operation information). A wild-card character may also be used in the definition of the destination of the operation information.

The mobile phone 11 is one example of a terminal apparatus. The mobile phone 11 includes a broadcast receiver 31, a storage section 32, a playback processor 33, a definition-information separator 34, an operation-log collection/transmission enabling/disabling determiner 35, a log collector 36, an operation log 37, an operation-information generator 38, a storage area 39, and a display/state manager 40.

The broadcast receiver 31 receives the content data 100 through broadcast waves. The storage section 32 stores the content data 100. The playback processor 33 plays back the content data 100 stored in the storage section 32. The definition-information separator 34 separates the content data 100 and the definition information 101. The operation-log collection/transmission enabling/disabling determiner 35 determines whether or not collection of the operation log 37 is enabled. The log collector 36 collects the operation log 37 of the mobile phone 11.

Based on the operation log 37, the operation-information generator 38 generates operation information 102 to be transmitted to the web server 12. The operation-log collection/transmission enabling/disabling determiner 35 determines whether or not transmission of the operation information 102 to the web server 12 is enabled. The operation information 102 is transmitted to the web server 12 in a web format, and thus, the storage area 39 may be referred to from a web browser (not shown).

The display/state manger 40 generates a TV-program video/motion picture 42 from the played back content data 100. A web screen 43, which is generated by the web browser, has a link or button 44 described below.

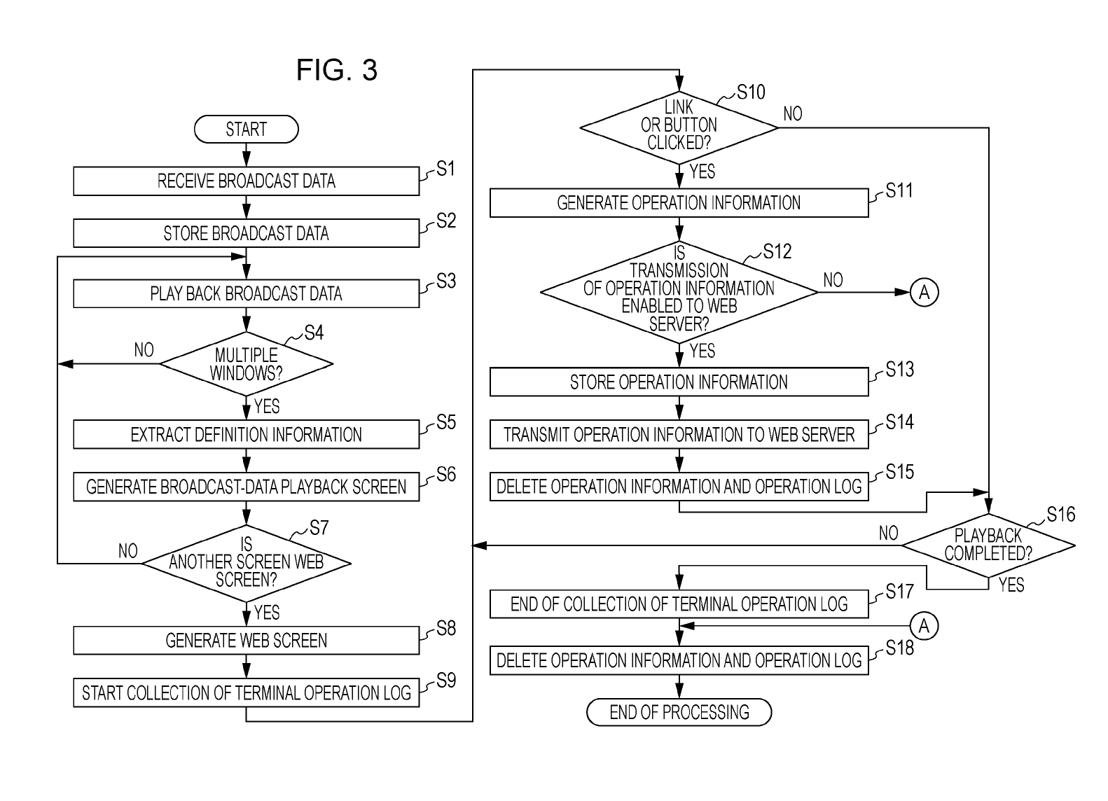

A processing procedure of the mobile phone 11 illustrated in FIG. 2 will now be described with reference to FIG. 3. FIG. 3 is a flowchart of one embodiment of a flow of processing of the mobile phone 11.

In step S1, the broadcast receiver 31 receives broadcast data (content data 100) having a header field that contains the definition information 101. In step S2, the broadcast receiver 31 stores the received content data 100 in the storage section 32.

In step S3, the playback processor 33 plays back the content data 100 stored in the storage section 32. In step S4, the operation-log collection/transmission enabling/disabling determiner 35 determines whether or not a TV-program video/motion picture 42 and another screen are displayed in multiple windows 41.

The operation-log collection/transmission enabling/disabling determiner 35 repeatedly performs the processing in step S4 until it is determined that display is performed in the multiple windows 41. Until the operation-log collection/transmission enabling/disabling determiner 35 determines that display is performed in the multiple windows 41, the display/state manager 40 receives the played back content data 100 via the definition-information separator 34, generates the TV-program video/motion picture 42 from the content data 100, and displays the generated TV-program video/motion picture 42. The display/state manager 40 continuously displays the TV-program video/motion picture 42.

On the other hand, when the operation-log collection/transmission enabling/disabling determiner 35 determines that display is performed in the multiple windows 41, the process proceeds to step S5. In step S5, the definition-information separator 34 separates and extracts the definition information 101 from the content data 100, supplies the content data 100 to the display/state manager 40, and also supplies the definition information 101 to the operation-log collection/transmission enabling/disabling determiner 35.

In step S6, the display/state manager 40 generates a TV-program video/motion picture 42 (a broadcast data playback screen) from the supplied content data 100 and displays the TV-program video/motion picture 42. The process then proceeds to step S7 in which the operation-log collection/transmission enabling/disabling determiner 35 determines whether or not another screen to be displayed simultaneously with the TV-program video/motion picture 42 is a web screen 43. When the other screen to be displayed in the multiple windows 41 simultaneously with the TV-program video/motion picture 42 is not a web screen 43, the process returns to step S3. On the other hand, when the other screen to be displayed simultaneously with the TV-program video/motion picture 42 is a web screen 43, the process proceeds to step S8 in which the web browser generates a web screen 43 and displays the web screen 43 in the multiple windows 41 simultaneously with the TV-program video/motion picture 42.

The process then proceeds to step S9, in which the operation-log collection/transmission enabling/disabling determiner 35 issues an instruction for starting collection of the operation log 37 to the log collector 36. In this manner, the operation-log collection/transmission enabling/disabling determiner 35 enables collection of the operation log 37 when the TV-program video/motion picture 42 and the web screen 43 are simultaneously displayed in the multiple windows 41.

The log collector 36 collects, as the operation log 37, the title, broadcast date, and playback time of the TV-program video/motion picture 42 in accordance with the collection-information types contained in the definition information 101. A user key press and so on, in addition to the title, broadcast date, and playback time of the TV-program video/motion picture 42, may also be collected as the operation log 37.

In step S10, the web browser determines whether or not the link or button 44 on the web screen 43 is clicked. Upon determining that the link or button 44 on the web screen 43 is clicked, the web browser issues a notification indicating the determination to the operation-information generator 38.

In step S11, the operation-information generator 38 generates operation information 102 to be transmitted to the web server 12, based on the operation log 37. In step S12, in accordance with a destination address contained in the definition information 101, the operation-log collection/transmission enabling/disabling determiner 35 determines whether or not transmission of the operation information 102 to the web server 12 is enabled.

Thus, when the address of the web server 12 is the same or substantially the same as the destination address contained in the definition information 101, the operation-log collection/transmission enabling/disabling determiner 35 enables the transmission of the operation information 102 to the web server 12.

When the transmission of the operation information 102 to the web server 12 is enabled, the process proceeds to step S13 in which the operation-log collection/transmission enabling/disabling determiner 35 stores the operation information 102 in the storage area 39 that may be referred to from the web browser. In step S14, the web browser refers to the storage area 39 to transmit the operation information 102 to the web server 12. In step S15, the operation information 102 and the operation log 37 are deleted.

When the processing in step S15 is finished or when it is determined in step S10 that the link or button 44 on the web screen 43 has not been clicked, the process proceeds to step S16 in which the display/state manager 40 determines whether or not the playback of the content data 100 is completed. When the playback of the content data 100 is not completed, the process returns to step S10. When the playback of the content data 100 is completed, the process proceeds to step S17 in which the operation-log collection/transmission enabling/disabling determiner 35 issues, to the log collector 36, an instruction for ending the collection of the operation log 37.

When the processing in step S17 is finished or when it is determined in step S12 that the transmission of the operation information 102 to the web server 12 is not enabled, the process proceeds to step S18. In step S18, the operation information 102 and the operation log 37 are deleted, thereby ending the processing illustrated in the flowchart of FIG. 3.

Now, a description will be given of an example in which the mobile phone 11 receives a soccer-game broadcast program, stores the broadcast program as content data 100, and plays back the content data 100 at another time.

When the content data 100 is to be played back, the user may, for example, attempt to obtain information on players and the team(s) participating in the game by searching on the Web. The user may also check information of the country or the city where the game is being played. In addition, the user may plan to make a trip reservation to go to see a game. Furthermore, while viewing the broadcast content, the user may collect further information or use an information service by utilizing a web site (web server 12).

The mobile phone 11 has a display section, such as a display. The mobile phone 11 may display broadcast content and may display internet content, such as web sites (web pages). For example, by using a multiple window function, the mobile phone 11 may simultaneously display the broadcast content and the Internet content.

The mobile phone 11 has an input section including input buttons and so on. If the mobile phone 11 is a smart phone, a PDA (personal digital assistant), or the like, the input section may have a small keyboard. FIG. 2 illustrates an example in which during playback and display of broadcast content as the TV-program video/motion picture 42, the mobile phone 11 accesses the web server 12 of a search engine site or the like, and during playback of the broadcast content, the mobile phone 11 transmits the collected user-operation history of the mobile phone 11 to the web server 12 as the operation information 102.

In the example illustrated in FIG. 2, by inserting a form into a definition for a screen to be displayed on the web browser of the mobile phone 11, the web server 12 may arrange a link or button 44, defined by the form, on the web screen 43. When the user selects or presses the link or button 44 defined by the form, the web browser may transmit the operation information 102 together with an HTTP (hyper text transfer protocol) POST command to the web server 12.

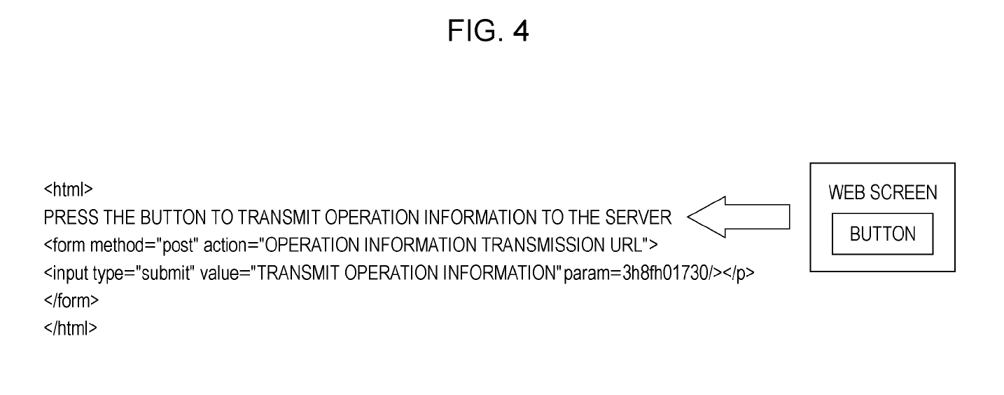

FIG. 4 illustrates one example of the form that defines a link or button. The form in FIG. 4 shows an example in which a button 44 is displayed on the web screen 43 and pressing the button 44 causes the operation information 102 to be transmitted to an operation information transmission URL (uniform resource locator). For example, the button 44 is used to explicitly transmit the operation information 102, and/or a link 44 is used to implicitly transmit the operation information 102.

The mobile phone 11 typically requires a web browser to access the web server 12 to display the web screen 43. Thus, the operation information 102 is preferably set in a state accessible from the web browser. The mobile phone 11 in the present embodiment includes the storage area 39 that may be temporarily accessible from the web browser (which is one example of application software) prepared in a memory or on a disk.

The storage area 39 is an area to which the web browser may refer while accessing the web server 12. The operation information 102 stored in the storage area 39 is deleted immediately after the operation information 102 is transmitted to the web server 12 or when the playback of broadcast content is suspended.

For example, the operation information 102 contains the title of played back broadcast content, an actual broadcast date of the played back broadcast content, and the playback time with the mobile phone 11. In addition, when the broadcast content is a motion picture, the operation information 102 may contain, for example, playback duration from the beginning or a frame number when the broadcast content is rewound and played back. Identifying a rewound and played back broadcast-content segment is desirable in order to recognize in which scene of the broadcast content the user is interested.

The operation information 102 is collected during playback of the broadcast content. The operation information 102 is transmitted to only the web server 12 that is identified by the destination address contained in the definition information 101 for the content data 100. Control for accessing the web server 12 to which the operation information 102 is to be transmitted and determination as to whether to enable the transmission of the operation information 102 may be limited by a system using a key (described below) as well as a system for specifying a destination address.

The destination address may indicate an individual URL or may indicate a unit having a certain length (e.g., a unit representing a company name). For example, when the destination address is “*.abc.com”, the operation information 102 may be transmitted to a web server 12 having an URL that includes “.abc.com”.

### Second Embodiment

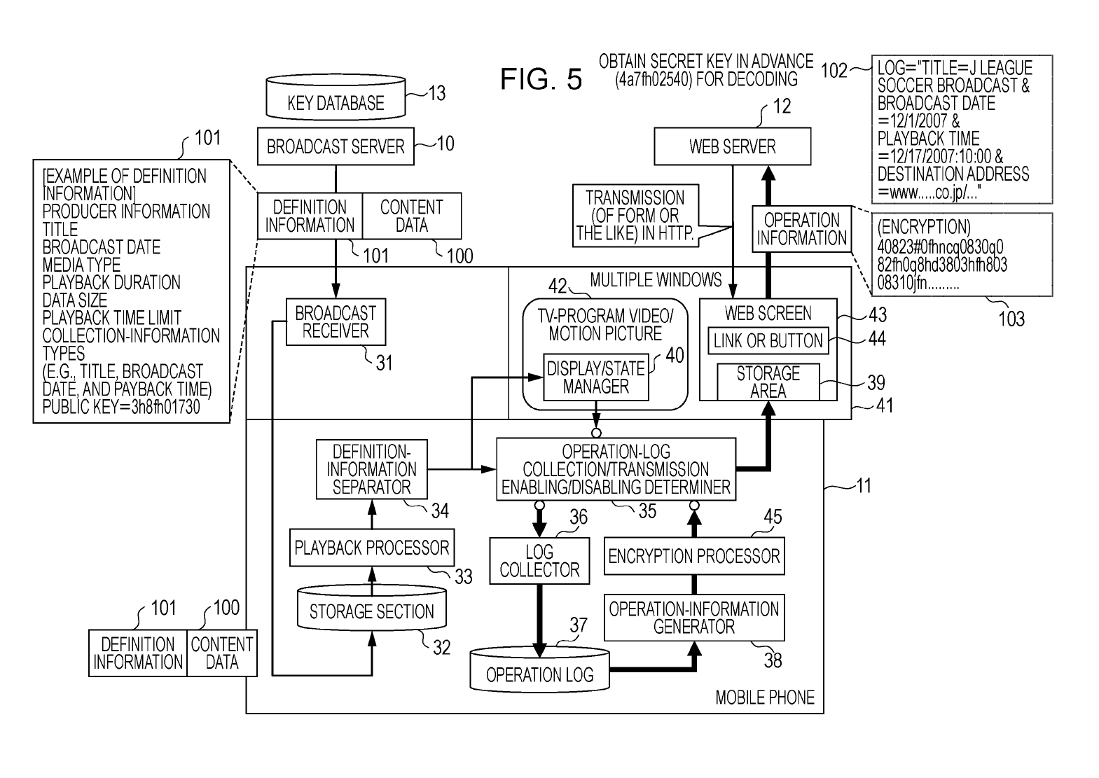

FIG. 5 is a block diagram illustrating an operation-information collecting system according to another embodiment. Since the block diagram in FIG. 5 is the same as the block diagram in FIG. 2 except for some sections, the same sections are denoted by the same reference numerals and descriptions thereof are omitted accordingly.

An operation-information collecting system 1 in FIG. 5 includes a broadcast server 10, a mobile phone 11, and a web server 12, as in the operation-information collecting system 1 in FIG. 2, and further includes a key database 13.

The broadcast server 10 applies a public key to the definition information 101 as a replacement for the destination address in the definition information 101 illustrated in FIG. 2. A key stored in the key database 13 may be used as the public key contained in the definition information 101 in FIG. 5. In the definition information 101 in FIG. 5, a character string “3h8fh01730” is used as the public key. The public key, however, does not necessarily have to be a character string and may be any information, such as binary data, that is manageable as secret information.

The mobile phone 11 in FIG. 5 includes a broadcast receiver 31, a storage section 32, a playback processor 33, a definition-information separator 34, an operation-log collection/transmission enabling/disabling determiner 35, a log collector 36, an operation log 37, an operation-information generator 38, a storage area 39, and a display/state manager 40, similarly to the mobile phone 11 in FIG. 2, and further includes an encryption processor 45.

By using the public key contained in the definition information 101, the encryption processor 45 encrypts operation information 102, generated by the operation-information generator 38, to generate encrypted operation information 103. The operation-log collection/transmission enabling/disabling determiner 35 determines whether to enable transmission of the operation information 102 to the web server 12. The encrypted operation information 103 is transmitted to the web server 12 in a web format, and thus, the storage area 39 may be referred to from a web browser (not shown).

A web server 12 obtains a secret key in advance from the broadcast server 10. Examples of a method for obtaining the secret key in advance include a method for obtaining the secret key from the broadcast server 10 online and a method for obtaining the secret key from the company of the broadcast server 10 as part of a contract or another regular business transaction.

The web server 12 uses the secret key to decode the encrypted operation information 103 into its original operation information 102. Without obtaining the secret key, the web server 12 cannot decode the encrypted operation information 103 into its original operation information 102 and thus cannot use the operation information 102. With this arrangement, the operation-information collecting system 1 in FIG. 5 may define the destination of the operation information 102 by using the public key contained in the definition information 101 and may limit the destination of the operation information 102.

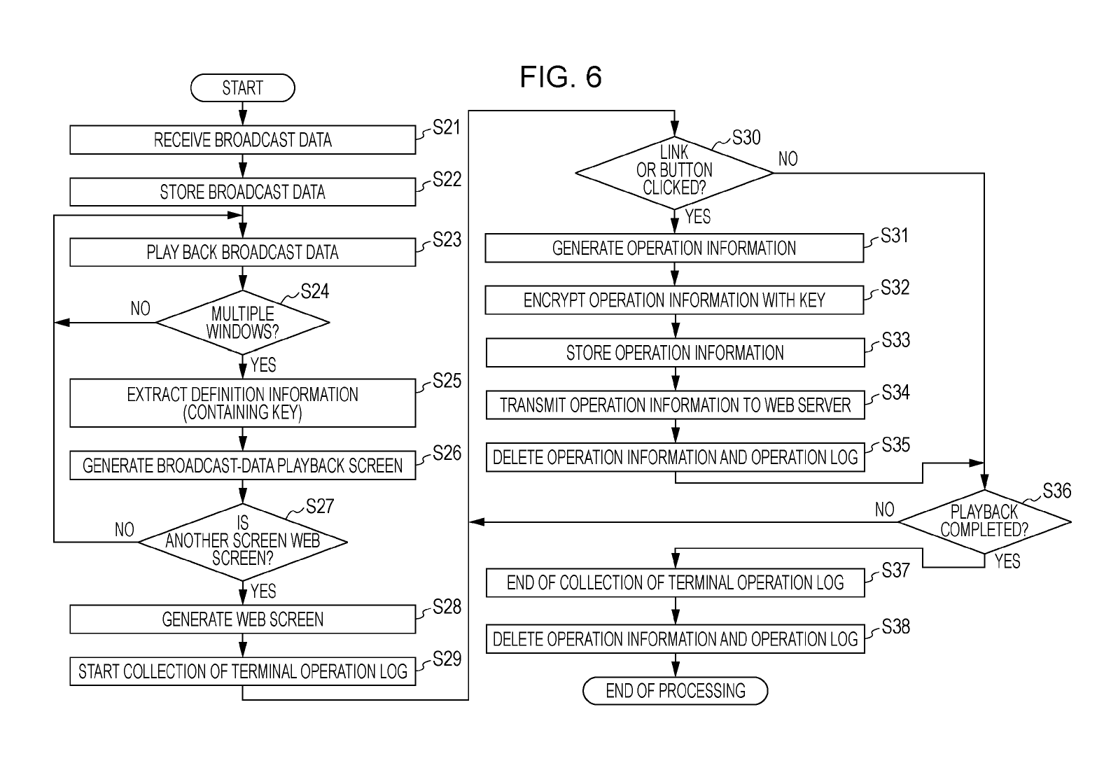

A processing procedure of the mobile phone 11 illustrated in FIG. 5 will now be described with reference to FIG. 6. FIG. 6 is a flowchart of one embodiment of a flow of processing of the mobile phone 11. Since the flowchart in FIG. 6 is the same as the flowchart in FIG. 3 except for some steps, the same steps are denoted by the same reference numerals and descriptions thereof are omitted accordingly.

Processing in steps S21 to S24 is analogous to the processing in steps 51 to S4 in FIG. 3. When it is determined in step S24 that display is performed in multiple windows 41, the process proceeds to step S25. In step S25, the definition-information separator 34 separates and extracts the definition information 101 from the content data 100, supplies the content data 100 to the display/state manager 40, and also supplies the definition information 101 to the operation-log collection/transmission enabling/disabling determiner 35. The definition information 101 extracted in this case contains a public key.

Processing in steps S26 to S31 is analogous to the processing in steps S6 to S11 in FIG. 3. In step S32, by using the public key contained in the definition information 101, the encryption processor 45 encrypts the operation information 102 to generate encrypted operation information 103.

In step S33, the operation-log collection/transmission enabling/disabling determiner 35 stores the encrypted operation information 103 in the storage area 39 that may be referred to from the web browser. In step S34, the web browser refers to the storage area 39 to transmit the encrypted operation information 103 to the web server 12. In step S35, the encrypted operation information 103 and the operation log 37 are deleted.

When the processing in step S35 is finished or when it is determined in step S30 that a link or button 44 on a web screen 43 has not been clicked, the process proceeds to step S36 in which the display/state manager 40 determines whether or not the playback of the content data 100 is completed. When the playback of the content data 100 is not completed, the process returns to step S30.

When the playback of the content data 100 is completed, the process proceeds to step S37. In step S37, the operation-log collection/transmission enabling/disabling determiner 35 issues, to the log collector 36, an instruction for ending the collection of the operation log 37. In step S38, the encrypted operation information 103 and the operation log 37 are deleted and the processing illustrated in the flowchart in FIG. 6 ends.

### Third Embodiment

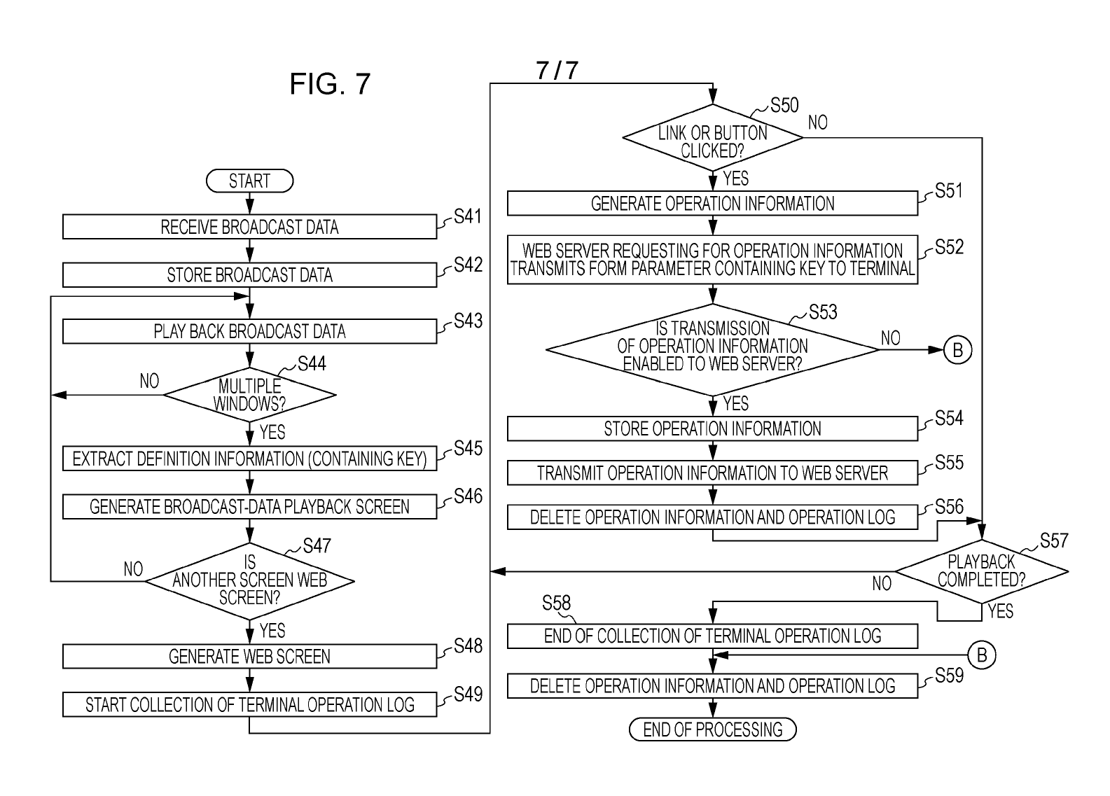

Although the public key contained in the definition information 101 is used to encrypt the operation information 102 in the flowchart in FIG. 6, a key contained in the definition information 101 may also be used for authentication of a web site (the web server 12), as illustrated in the flowchart in FIG. 7.

FIG. 7 is a flowchart of one embodiment of a flow of processing of the mobile phone 11. Since the flowchart in FIG. 7 is the same as the flowchart in FIG. 3 except for some steps, the same steps are denoted by the same reference numerals and descriptions thereof are omitted accordingly. A description below is given in conjunction with the block diagram illustrated in FIG. 2. In this case, however, the broadcast server 10 contains a public key as a replacement for the destination address in the definition information 101 illustrated in FIG. 2.

Processing in steps S41 to S44 is analogous to the processing in steps S1 to S4 in FIG. 3. When it is determined in step S44 that display is performed in multiple windows 41, the process proceeds to step S45. In step S45, the definition-information separator 34 separates and extracts the definition information 101 from the content data 100, supplies the content data 100 to the display/state manager 40, and also supplies the definition information 101 to the operation-log collection/transmission enabling/disabling determiner 35. The definition information 101 extracted in this case contains a key.

Processing in steps S46 to S51 is analogous to the processing in steps S6 to S11 in FIG. 3. In step S52, the mobile phone 11 receives a key contained in, for example, a form definition (a form parameter) from the web server 12 that is requesting the operation information 102. The web server 12 obtains the key in advance from the broadcast server 10. Examples of a method for obtaining the key in advance include a method for obtaining the key from the broadcast server 10 online and a method for obtaining the key from the company of the broadcast server 10 as part of a contract or another regular business transaction.

In step S53, when the key contained in the definition information 101 and the key received from the web server 12 match, the operation-log collection/transmission enabling/disabling determiner 35 enables transmission of the operation information 102 to the web server 12. Processing in steps S54 to S59 is analogous to the processing in steps 513 to 518 in FIG. 3.

In the operation-information collecting system 1, when the mobile phone 11 is to play back stored broadcast content, the operation log 37 may be collected during playback thereof. Alternatively, information that serves as a trigger may be embedded in data of broadcast content to be played back. In this case, when the trigger information is detected, information in the operation log 37, such as the playback title, frame number, and playback time, may be collected.

The trigger information may be simply a numeric value representing a flag. Alternatively, the trigger information may be semantic information attached, in the form of a character string, to the data of broadcast content to be played back, in accordance with the displayed contents of the broadcast content. Examples of the semantic information include the name of a show business person, artist, actor/actress, and sports figure, as well as the type of scenery and/or the name of a city. During collection of information in the operation log 37, the character string of the semantic information may also be recorded together with the broadcast content.

With this arrangement, the operation-information collecting system 1 may not only extract the type of viewed and/or listened broadcast content, but also easily extract the semantic information of the broadcast content, thereby facilitating subsequent extraction processing for user preference information.

As opposed to a known method in which information to be viewed and/or listened to may be collected only during real-time broadcast reception, the operation-information collecting system 1 may also collect the operation information 102, which is information regarding viewing and/or listening of various types of broadcast content stored on the mobile phone 11. Use of the operation information 102 for another service provided by the web server 12 or the like allows the operation information collecting system 1 according to the embodiment to provide a more enhanced service for users.

In this case, the operation information collecting system 1 may prevent the operation information 102 of the user from being transmitted to a web server 12 of an unrelated service provider and also may control the user's privacy protection.

In addition, the providers of web sites may specifically know what type of broadcast content is played back and to which segment the broadcast content is played back when particular web content is accessed, and thus may understand users' needs and preferences with high accuracy.

In addition, content producers and content distributers may understand the degree of influence that video content, such as TV programs, commercials, and so on has on other services and thus may apply the degree of influence to statistics information for setting of advertisement fees and improvement of the contents of the commercials.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A terminal apparatus comprising:
a receiving unit for receiving content data having definition information containing information regarding collection of operation information and information limiting a destination of the operation information;
a playback processing unit for playing back the content data;
a separating unit for separating the definition information from the content data;
an operation-log collecting unit for collecting an operation log based on the information regarding the collection of the operation information;
an operation-information generating unit for generating operation information from the operation log;
a transmission enabling/disabling determining unit for determining whether or not transmission of the operation information is enabled, based on the information limiting the destination of the operation information; and
a transmitting unit for transmitting the operation information to an information collecting server in response to a user operation that causes data communication, when the transmission enabling/disabling determining unit determines that transmission of the operation information is enabled.

2. The terminal apparatus according to claim 1, further comprising a collection enabling/disabling determining unit for enabling the operation-log collecting unit to collect the operation log during playback of the content data.

3. The terminal apparatus according to claim 1, wherein the information limiting the destination of the operation information contains a destination address of the operation information, and when an address of the information collecting server is included in the destination address of the operation information, the transmission enabling/disabling determining unit determines that the transmission of the operation information is enabled.

4. The terminal apparatus according to claim 1, wherein the information limiting the destination of the operation information contains a public key associated with a secret key held by the information collecting server;
the transmission enabling/disabling determining unit causes an encryption processing unit to encrypt the operation information by using the public key; and
the transmitting unit transmits the encrypted operation information to the information collecting server in response to the user operation that causes the data communication.

5. The terminal apparatus according to claim 1, wherein the information limiting the destination of the operation information contains a first key, and when the first key is the same as a second key received from the information collecting server, the transmission enabling/disabling determining unit determines that the transmission of the operation information is enabled.

6. An operation-information collecting system comprising:
a content transmitting server that transmits content data having definition information containing information regarding collection of operation information and information limiting a destination of the operation information;
a terminal apparatus including
a receiving unit for receiving the content data from the content transmitting server,
a playback processing unit for playing back the content data,
a separating unit for separating the definition information from the content data,
an operation-log collecting unit for collecting an operation log based on the information regarding the collection of the operation information,
an operation-information generating unit for generating operation information from the operation log,
a transmission enabling/disabling determining unit for determining whether or not transmission of the operation information is enabled, based on the information limiting the destination of the operation information, and
a transmitting unit for transmitting the operation information in response to a user operation that causes data communication, when the transmission enabling/disabling determining unit determines that the transmission of the operation information is enabled; and
an information collecting server that receives the operation information from the terminal apparatus.
